(19) United States
(12) Patent Application Publication
(10) Pub. No.: US 2025/0151948 A1
(43) Pub. Date: May 15, 2025

(54) SELF-CLEANING BEVERAGE STIRRER

(71) Applicant: Eric MARCARIAN, Valrico, FL (US)

(72) Inventor: Eric MARCARIAN, Valrico, FL (US)

(21) Appl. No.: 18/510,141

(22) Filed: Nov. 15, 2023

(51) Int. Cl. A47J 31/60; A47J 31/44

(52) U.S. Cl. CPC A47J 31/60; A47J 31/4403

(57) ABSTRACT

Systems and methods describe a beverage stirring device configured for an automated cleaning process performed on a stirrer between uses. The device may include a first stirrer and a cleaning station. The device may be configured to automatically transition the first stirrer between a stirring station and the cleaning station to be cleaned prior to a next stirring.

### FIELD

The present disclosure relates generally to apparatuses and devices that stir beverages after a drinking cup, glass, or vessel is filled with contents and additions and/or mix-ins are added.

The present disclosure relates more specifically to apparatuses and devices that stir coffee, tea, and powdered beverages after a drinking vessel is filled with contents and additions and/or mix-ins are added.

### SUMMARY

Systems and methods describe a beverage stirring device configured for an automated cleaning process performed on a stirrer between uses. The device may include a first stirrer and a cleaning station. The device may be configured to automatically transition the first stirrer between a stirring station and the cleaning station to be cleaned prior to a next stirring.

The device may further comprise a second stirrer, wherein the first stirrer and the second stirrer are coupled to a carousel for rotation of the first and second stirrers about an axis of the carousel.

The carousel may be coupled to an arm configured to move the first and second stirrers from a raised position to a lowered stirring position.

The device may comprise a controller that controls rotation of the first and second stirrers about the carousel axis and movement of the carousel between the raised and stirring positions.

The cleaning station may comprise a cleaning vessel and a fill tank fluidly coupled to the cleaning vessel. The cleaning station may further comprise a drying fan. The cleaning station has a cleaning vessel and a steam sterilization source. The cleaning station may have a radiation source.

The device may further comprise a controller configured to control one of a fluid pump, a radiation source, a steam sterilization source, or fan in the cleaning station to clean the first stirrer.

The device may further comprise a second stirrer and a carousel, the first and second stirrer coupled equidistantly from each other on the carousel, wherein when the first stirrer is positioned in the stirring station, the second stirrer is positioned in the cleaning station.

The device may further comprise a controller configured to move the carousel from a raised position to a stirring position, and rotate the first and second stirrers on first and second stirrer longitudinal axes while the first stirrer stirs a liquid in a container at the stirring station and the second stirrer is cleaned at the cleaning station.

The device may further comprise a second stirrer, wherein the first stirrer and the second stirrer are configured to rotate about respective longitudinal axes simultaneously or rotated independently.

The first and second stirrers may be coupled to a carousel and rotation of the carousel positions the first stirrer at the beverage stirring station and the second stirrer at the cleaning station, so that the first stirrer stirs a liquid in the beverage stirring station and the second stirrer is cleaned simultaneously at the cleaning station.

The device may further comprise a divider wall to separate the beverage stirring station from the beverage cleaning station. The beverage stirring station may have a cup placement area.

### BRIEF DESCRIPTION OF THE DRAWINGS

FIG. 1 is a perspective view of the drink stirrer according to the disclosed embodiments;

FIG. 2 is a rear angled perspective view of the drink stirrer according to the disclosed embodiments; and

FIG. 3 is a flowchart of a method of automatically stirring a beverage and cleaning the stirrer according to the disclosed embodiments.

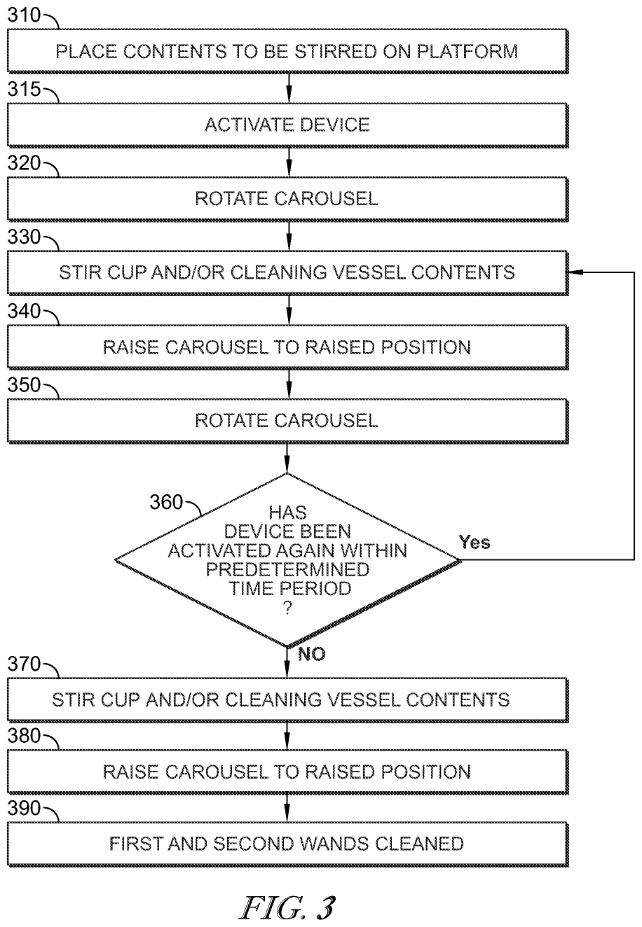

### DETAILED DESCRIPTION

The detailed embodiments of a drink stirrer device are disclosed herein. The disclosed embodiments are merely exemplary of the drink stirrer, which may be embodied in various forms. The details disclosed herein are not to be interpreted as limiting, but merely as the basis for the claims and as a basis for teaching one skilled in the art how to make and use the drink stirrer.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “cleaning” and/or “sterilization”, or any variations thereof, will be understood to imply the inclusion of removing residues, particles, flavorings, germs or viruses, or potential allergens. For the purposes of promoting an understanding of the principles of the disclosure, reference will now be made to a number of illustrative embodiments illustrated in the drawings and specific language will be used to describe the same.

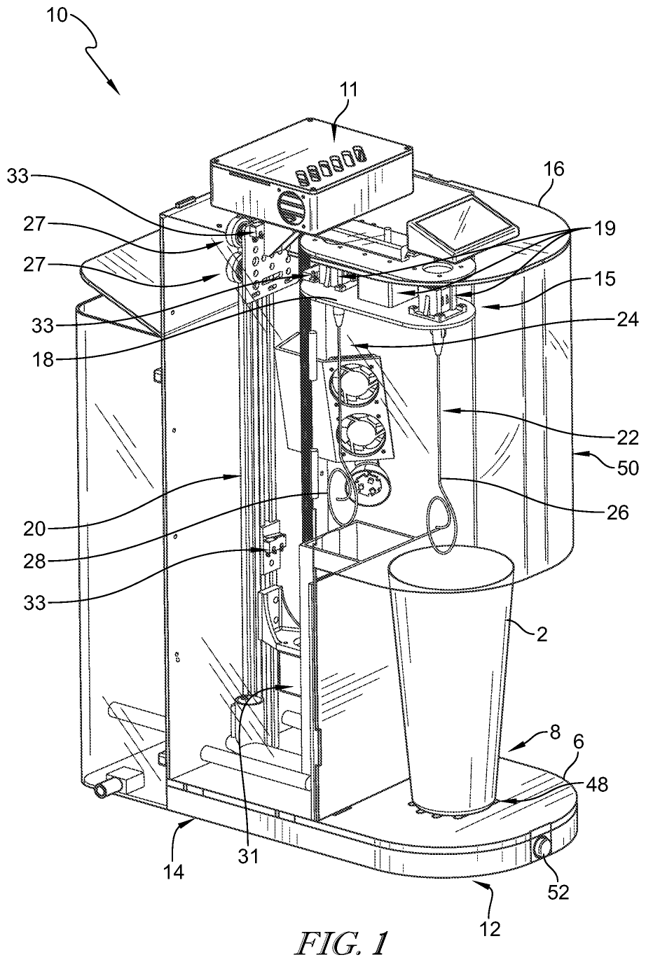

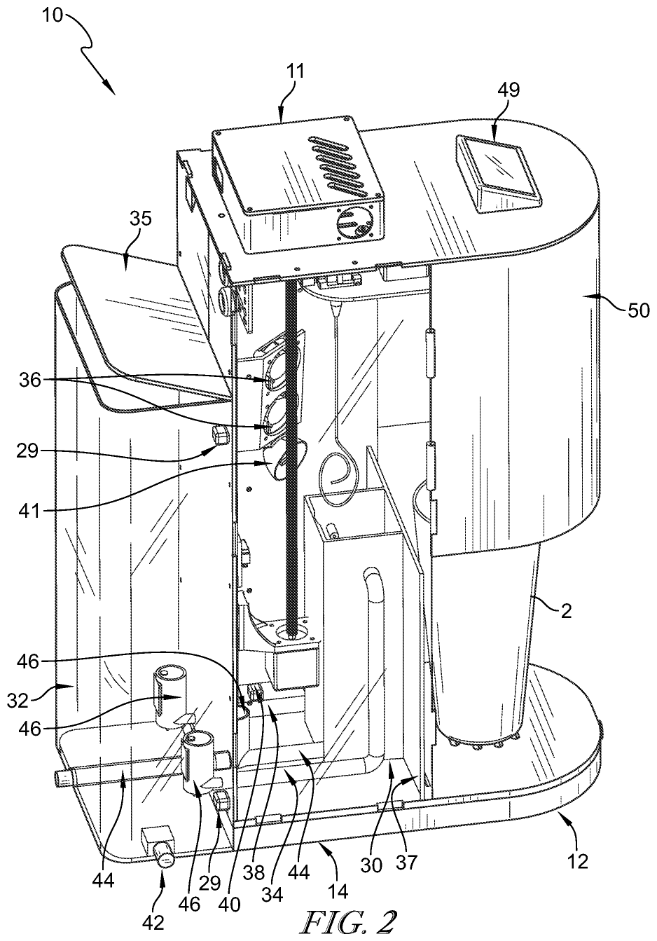

In the illustrative embodiment in FIG. 1, a stirring device 10 is shown having a beverage stirring station 12 and a cleaning station 14 and a beverage stirring body 15 that interacts with both the beverage stirring station 12 and cleaning station 14. Platform 6 may be formed continuously between the beverage stirring and cleaning stations 12, 14 with a cup placement area 8 in the beverage stirring station that includes drainage vents 48, and may be hinged or otherwise slide to expose a trap area for the liquid passing through the vents to clean the trap area. Controller 11 may be coupled to the device body 16 and configured to control operations of the beverage stirring station 12, cleaning station 14, and beverage stirring body 15. Beverage stirrer body 15 may include a stirring carousel 18, coupled to an arm 20 of device body 16. The carousel may be driven by a motor 19 and include one or more drink stirrers 22, 24, the motor permitting rotation of the one or more drink stirrers 22, 24 about a vertical axis as well as rotation of each drink stirrer 22, 24 about its respective longitudinal axis to stir a liquid. Alternatively, each drink stirrer 22, 24 may have its own motor to drive stirrer rotation in addition to carousel motor 19. The stirring carousel 18 may by coupled to the arm 20 via a moving mechanism, such as a plurality of rollers 27 and motor 31 allowing vertical movement of the carousel 18 and drink stirrers 22, 24. A plurality of sensors or switches 33 coupled to the carousel 18 and arm 20 may provide upper, raised, and lower, stir, positions of the carousel 18, and the switch 33 on the carousel may provide a determination of which end of the carousel is rotated towards arm 20. Drink stirrers 22, 24, may include removably mounted stirrer wands 26, 28, terminating in any of a plurality of shapes such as circles, at the distal end to stir a liquid. Hood shield 50 may be coupled to the top and side body of the stirring device 10 and extend down towards the platform 6 the length of mounted stirring wand 26 in the fully raised position. Although hood and other portions of the body are illustrated as transparent, they may also be opaque as seen for example in the illustration of hood 50 in FIG. 2 Indicator 52, such as an LED indicator may provide color indication of when the device 10 is ready for a vessel 2 to be placed on the platform 6 for stirring. For example, red may indicate the device is in use, or otherwise not ready, while green may indicate the device is ready for a cup or other vessel to be placed on or removed from the platform.

As seen in FIG. 2, cleaning station 14 may be located at the back of the stirring device 10, and may include a cleaning vessel 30, a cleaning liquid fill tank 32 and cleaning vessel input tubing line 34 and output tubing line 44. Cleaning vessel input tubing line 34 interconnects the cleaning vessel 30 and cleaning fill tank 32 allowing liquid to be transferred between the cleaning vessel 30 and liquid fill tank 32. Fill tank may also include a lid 35, allowing manual filling of the tank with cleaning solution and upper and lower fill tank solution level sensors 29. Cleaning vessel 30 may include a divider wall 37 formed on one side of the cleaning vessel 30 and extending the width of a stirring device platform 6 to separate the cleaning station 14 from the beverage stirring station 12. In some embodiments, divider wall may be separated from the cleaning vessel 30. Input tube 42, may include a pump, and may couple a fluid source to the liquid fill tank 32 and output tube 44 may couple the cleaning vessel 30 to an external waste line or other external vessel for removing the fluid contents from the cleaning vessel 30. In some embodiments, cleaning vessel may include a moisture sensor in the interior of the vessel, to sense moisture levels and control pumps 46. Cleaning station may include a further tubing input 38 and steam generator 40, such as a steam generating solenoid valve, coupled between cleaning fill tank 32 and cleaning vessel 30 to provide a steam sterilization in the cleaning vessel 30. The various input and output tubes described may include one or more pumps 46 to drive the fluid. Cleaning station 14 may additionally include a radiation source 41, such as a UV-C LED light, or ultrasonic transducer, positioned to direct radiation towards the cleaning vessel 30. In some embodiments, cleaning station 14, may also include one or more fans 36 positioned to force air in a direction of the cleaning vessel 30 to dry a stirrer wand 26, 28. Although the radiation source 41 is illustrated coupled to the fans 36, which are illustrated coupled to a vertical portion of the device body 16, it is envisioned that these components can be coupled to other areas of the device in order to achieve their cleaning and drying functions. For example, the radiation source 41 may be coupled to the cleaning vessel 30 or integrated into a sidewall of the cleaning vessel.

Stirring device 10 may further include a user interface 49 coupled to controller 11 for controlling operations of the stirring device 10, the beverage stirring station 12, and the beverage cleaning station 14. User interface 49 may be a series of buttons and LED screen, a touchscreen, or other controllable buttons or switches. Controller 11, includes a power supply, and may be coupled to sensors 33, motors 19, 31, pumps 46, as well as radiation source 34, fans 36, and steam generator 40 in order to control operations of the device 10.

In a method of operation, a cup or other vessel may be placed on a platform with contents to be stirred 310. The device is activated, for example by a command, button, or switch to start 315. The carousel rotates so that a newly sterilized stirring wand is positioned over the cup and stirring wand that was previously over the cup is positioned over a sterilization vessel 320. At a predetermined and adjustable time before, during, or after the carousel rotates, a cleaning liquid is pumped into the cleaning vessel either until a predefined volume is pumped or until a predefined fill line is sensed to be reached. In some embodiments, the sterilization fluid is a steam pumped into the cleaning vessel and, therefore, is pumped in as the stirrer begins lowering into the cleaning vessel towards the stirring position as well as during rotation of the stirring wand. The carousel lowers from a raised position to a stirring position. In the lowered stirring position, each stirrer or wand is then rotated about its longitudinal axis to stir either the cup or the cleaning vessel contents 330. Within the cup, the stirring wand may rotate to stir or mix the contents. Within the cleaning vessel, radiation, sterilization fluid, steam, or other sterilization may be activated to clean the stirring wand. Subsequently, the rotation of each stirrer or wand is stopped and the carousel is raised to the raised position 340. In some embodiments, the cleansed wand may rotate at an increased RPM relative to the beverage stirring RPM while being raised and still in the cleaning vessel and above the liquid to accelerate drying and reduce dripping. In some embodiments, the carousel raising speed may be reduced during this increased RPM of the cleansed wand. A fan may be activated on the wand that was just cleaned and the cup with stirred contents may be removed once the carousel is raised. Additionally, any liquid in the cleaning vessel may be emptied via draining tube. Subsequently, the carousel will rotate, bringing the cleaned stirred wand from the back to front for next use and the just-used soiled wand to the rear for cleaning 350. After this rotation, if the device is activated again 360, for example, if insufficient stirring has occurred, operations 330-350 will be repeated. If the carousel has remained in the raised position for a predetermined amount of time without an activation for stirring, i.e. a command or button, it will automatically trigger the cleaning process of once again lowering the carousel so that the recently used stirring wand, now in the rear, will be cleansed of residues by stirring the wand in contents of the sterilization vessel 370. The carousel will again be raised 380. A fan may be activated on the wand that was just cleaned and the cup with stirred contents may be removed once the carousel is raised. Additionally, any liquid in the cleaning vessel may be emptied via draining tube. Both first and second wands are now cleaned 390. The activation sequence is completed once both first and second wands have been cleaned 390.

Although the device is illustrated and described with two stirring wands, any number of wands including one, or more than two may be coupled to the carousel equidistantly to each other. Further, the wands may be configured to rotate simultaneously or be independently controllable for rotation about their respective axes.

In some embodiments, cleaning or sterilization liquid may be a Star San™ mixture by Fivestar Chemical Company, diluted Iodophor, or other known cleaning solutions.

In some embodiments, a cover or top may enclose the components and controller. In some embodiments, active cooling of electronics and motors is provided. In some embodiments, a side and divider wall and divider part that may mount to carousel separating wands from each other and wands from the user. In some embodiments, a bracket is provided to removably couple the cleaning vessel to the device.

In some embodiments, the lowered or stirring position is configured to position the stirring wand in a range of 0.5-1.5″ from the bottom of the platform or 0.75″ from the platform to better pick up solids while accounting for thickness of a drinking vessel's bottom layer. In some embodiments, the raised position is configured so that a clearance in a range of 7-14″ or 8″ is provided between the platform and the stirring wand distal end for a container to be placed on the platform underneath the stirring wand.

In some embodiments, the beverage stirring device further comprises a plurality of stirrers wherein two of said plurality of stirrers being said first stirrer and a second stirrer each configured to operate either independently or in synchronization with any combination of other stirrers.

In some embodiments, the beverage stirring device further comprises a plurality of cleaning vessels wherein two of said plurality of cleaning vessels being said first cleaning vessel and a second cleaning vessel.

According to some embodiments, the beverage stirring device further configured different automated modes via the user interface. The speed, force, or power input to the stirrer is variable and selectable to be suited to the beverage type or mixture type to be stirred.

Those skilled in the art will recognize, upon consideration of the above teachings, that the above exemplary embodiments and the controller may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out the above-described method operations and resulting functionality. In this case, the term “non-transitory” is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A beverage stirring device configured for an automated cleaning process performed on a stirrer between uses comprising:
a first stirrer,
and a cleaning station,
wherein the device is configured to automatically transition the first stirrer between a stirring station and the cleaning station to be cleaned prior to a next stirring.

2. The beverage stirring device of claim 1 further comprising a second stirrer, wherein the first stirrer and the second stirrer are coupled to a carousel for rotation of the first and second stirrers about an axis of the carousel.

3. The beverage stirring device of claim 2, wherein the carousel is coupled to an arm configured to move the first and second stirrers from a raised position to a lowered stirring position.

4. The beverage stirring device of claim 3, further comprising a controller that controls rotation of the first and second stirrers about the carousel axis and movement of the carousel between the raised and stirring positions.

5. The beverage stirring device of claim 1, wherein the cleaning station comprises a cleaning vessel and a fill tank fluidly coupled to the cleaning vessel.

6. The beverage stirring device of claim 5, wherein the cleaning station further comprises a drying fan.

7. The beverage stirring device of claim 1, wherein the cleaning station has a cleaning vessel and a steam sterilization source.

8. The beverage stirring device of claim 1, wherein the cleaning station has a radiation source.

9. The beverage stirring device of claim 1, further comprising a controller configured to control one of a fluid pump, a radiation source, a steam sterilization source, or fan in the cleaning station to clean the first stirrer.

10. The beverage stirring device of claim 1 further comprising a second stirrer and a carousel, the first and second stirrer coupled equidistantly from each other on the carousel, wherein when the first stirrer is positioned in the stirring station, the second stirrer is positioned in the cleaning station.

11. The beverage stirring device of claim 10, further comprising a controller configured to move the carousel from a raised position to a stirring position, and rotate the first and second stirrers on first and second stirrer longitudinal axes while the first stirrer stirs a liquid in a container at the stirring station and the second stirrer is cleaned at the cleaning station.

12. The beverage stirring device of claim 1, further comprising a second stirrer, wherein the first stirrer and the second stirrer are configured to rotate about respective longitudinal axes simultaneously or rotated independently.

13. The beverage stirring device of claim 12, wherein the first and second stirrers are coupled to a carousel and rotation of the carousel positions the first stirrer at the beverage stirring station and the second stirrer at the cleaning station, wherein the first stirrer stirs a liquid in the beverage stirring station and the second stirrer is cleaned simultaneously at the cleaning station.

14. The beverage stirring device of claim 1, further comprising a divider wall to separate the beverage stirring station from the beverage cleaning station.

15. The beverage stirring device of claim 14, wherein the beverage stirring station has a cup placement area.
